(19) United States
(12) Patent Application Publication
(10) Pub. No.: US 2022/0252352 A1
(43) Pub. Date: Aug. 11, 2022

(54) HEAT EXCHANGE CORE AND HEAT EXCHANGER

(71) Applicant: MITSUBISHI HEAVY INDUSTRIES, LTD., Tokyo (JP)

(72) Inventors: Koichiro IIDA, Tokyo (JP); Yoshiko OYA, Tokyo (JP); Takeshi KANEKO, Tokyo (JP); Yasuhiro SUGIMOTO, Tokyo (JP); Masaya HATANAKA, Tokyo (JP); Koichi TANIMOTO, Tokyo (JP); Hiroyuki NAKAHARAI, Tokyo (JP); Yoichi UEFUJI, Tokyo (JP)

(21) Appl. No.: 17/569,639

(22) Filed: Jan. 6, 2022

(30) Foreign Application Priority Data
Feb. 10, 2021 (JP) 2021-019471

(51) Int. Cl. F28D 7/00; F28F 9/02

(52) U.S. Cl. CPC F28D 7/0008; F28F 2210/08; F28F 2250/04; F28F 9/02

(57) ABSTRACT

A heat exchange core according to an embodiment includes a plurality of first layers including a plurality of first flow paths, a first header connected to the plurality of first flow paths, and a plurality of second layers including a plurality of second flow paths and disposed alternately with the first layers in a layering direction. The first header includes a first main header extending in the layering direction and a first sub header provided on each of the plurality of first layers and connected to the first main header. End portions of some of the plurality of first flow paths are connected to the first main header, and end portions of a remainder of the plurality of first flow paths are connected to the first sub header.

### CROSS-REFERENCE TO RELATED APPLICATIONS

This application claims the benefit of priority to Japanese Patent Application Number 2021-019471 filed on Feb. 10, 2021. The entire contents of the above-identified application are hereby incorporated by reference.

### TECHNICAL FIELD

The disclosure relates to a heat exchange core and a heat exchanger.

### RELATED ART

For example, a heat exchange element (heat exchange core) for performing heat exchange between two fluids includes a plurality of flow path groups extending along the flow direction of the fluids. When the two fluids flow through the plurality of flow path groups, heat exchange is performed between the two fluids via a partition wall or the like which separates the two fluids (see Japanese Patent No. 5797328, for example).

### SUMMARY

For example, in the case, as described in the patent document above, where a header space is configured to face the opening ends of the plurality of flow path groups in the heat exchange element and a fluid flows into the plurality of flow path groups from the header space, there is a concern that heat exchange efficiency may decrease due to variations in the flow rate of the fluid between flow paths. Thus, it is required to make the flow rate of the fluid as uniform as possible between the flow paths.

In view of the circumstances described above, an object of at least one embodiment of the disclosure is to provide a heat exchange core having excellent heat exchange efficiency.

(1) A heat exchange core according to at least one embodiment of the present disclosure includes:

a plurality of first layers including a plurality of first flow paths;

a first header connected to the plurality of first flow paths; and

a plurality of second layers including a plurality of second flow paths and disposed alternately with the plurality of first layers in a layering direction, wherein

the first header includes a first main header extending in the layering direction and a first sub header provided on each of the plurality of first layers and connected to the first main header,

end portions of some of the plurality of first flow paths are connected to the first main header, and

end portions of a remainder of the plurality of first flow paths are connected to the first sub header.

(2) A heat exchanger according to at least one embodiment of the disclosure includes the heat exchange core having the configuration according to (1) described above.

According to at least one embodiment of the disclosure, a heat exchange core having excellent heat exchange efficiency can be provided.

### BRIEF DESCRIPTION OF DRAWINGS

The disclosure will be described with reference to the accompanying drawings, wherein like numbers reference like elements.

FIG. 1 is a schematic perspective view of a heat exchange core in a heat exchanger according to some embodiments.

FIG. 2 is a cross-sectional view taken along line II-II in FIG. 1.

FIG. 3 is a cross-sectional view taken along line in FIG. 2.

FIG. 4 is a cross-sectional view taken along line IV-IV in FIG. 2.

FIG. 5 is a cross-sectional view of a heat exchange core according to an embodiment taken along line V-V in FIG. 1.

FIG. 6 is a cross-sectional view of a heat exchange core according to another embodiment taken along line V-V in FIG. 1.

FIG. 7 is a schematic perspective cross-sectional view of a region from a first main header or a first sub header to first flow paths and a region from a second main header or a second sub header to second flow paths.

FIG. 8 is a schematic perspective cross-sectional view of a region from a first main header or a first sub header to first flow paths and a region from a second main header or a second sub header to second flow paths.

### DESCRIPTION OF EMBODIMENTS

Hereinafter, some embodiments of the disclosure will be described with reference to the accompanying drawings. However, dimensions, materials, shapes, relative arrangements, or the like of components described in the embodiments or in the drawings are not intended to limit the scope of the disclosure thereto, and are merely illustrative examples. For instance, an expression indicating relative or absolute arrangement such as “in a direction”, “along a direction”, “parallel”, “orthogonal”, “centered”, “concentric” or “coaxial” shall not be construed as indicating only the arrangement in a strict literal sense, but also includes a state where the arrangement is relatively displaced by a tolerance, or by an angle or a distance within a range in which the same function can be achieved.

For instance, an expression indicating an equal state such as “same”, “equal”, or “uniform” shall not be construed as indicating only a state in which features are strictly equal, but also includes a state in which there is a tolerance or a difference within a range in which the same function can be achieved.

Further, for instance, an expression indicating a shape such as a rectangular shape or a cylindrical shape shall not be construed as only being a geometrically strict shape, but also includes a shape with unevenness, chamfered corners or the like within a range in which the same effect can be achieved.

On the other hand, an expression such as “comprise”, “include”, “have”, “contain” or “constitute” is not intended to be exclusive of other constituent elements.

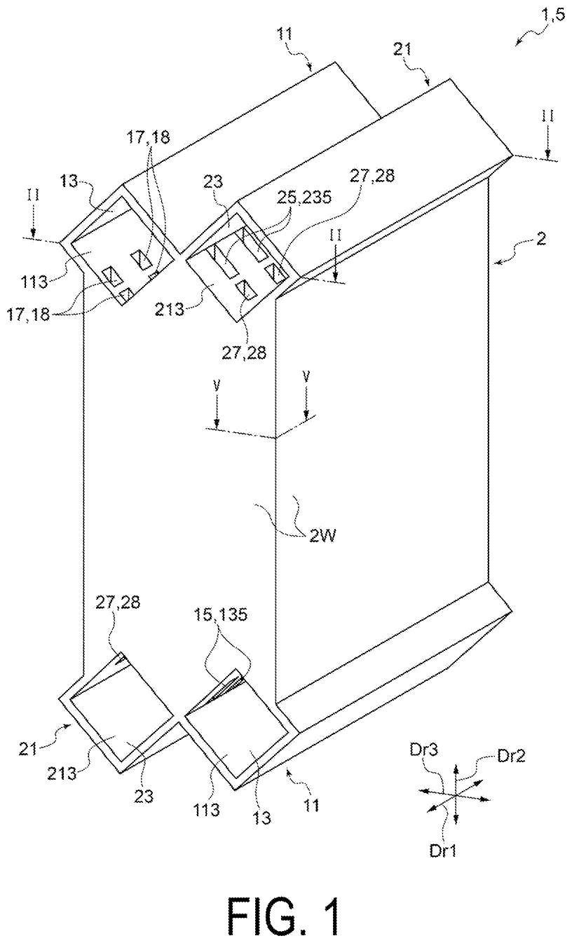

FIG. 1 is a schematic perspective view of a heat exchange core in a heat exchanger according to some embodiments.

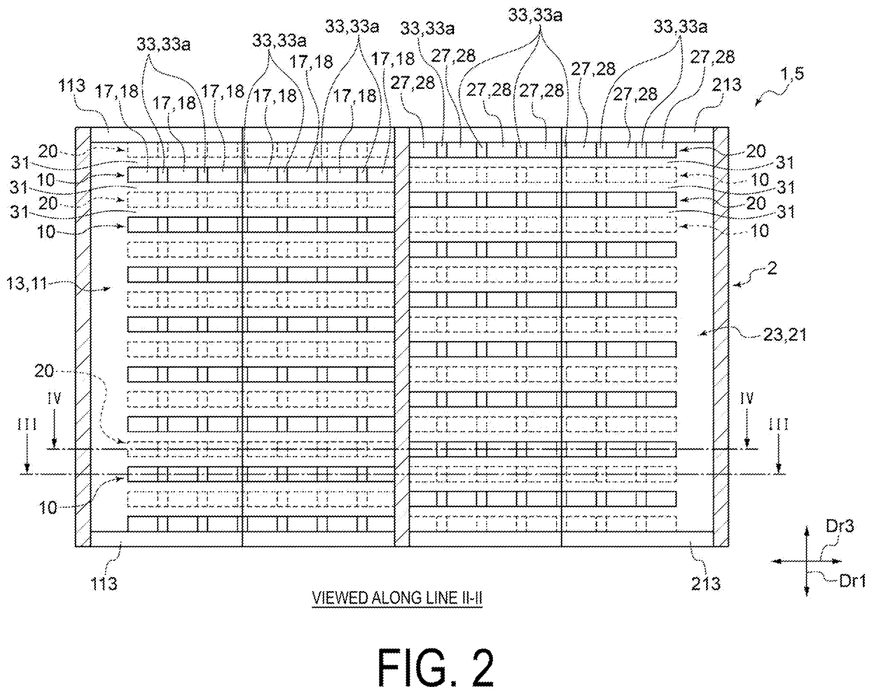

FIG. 2 is a cross-sectional view taken along line II-II in FIG. 1.

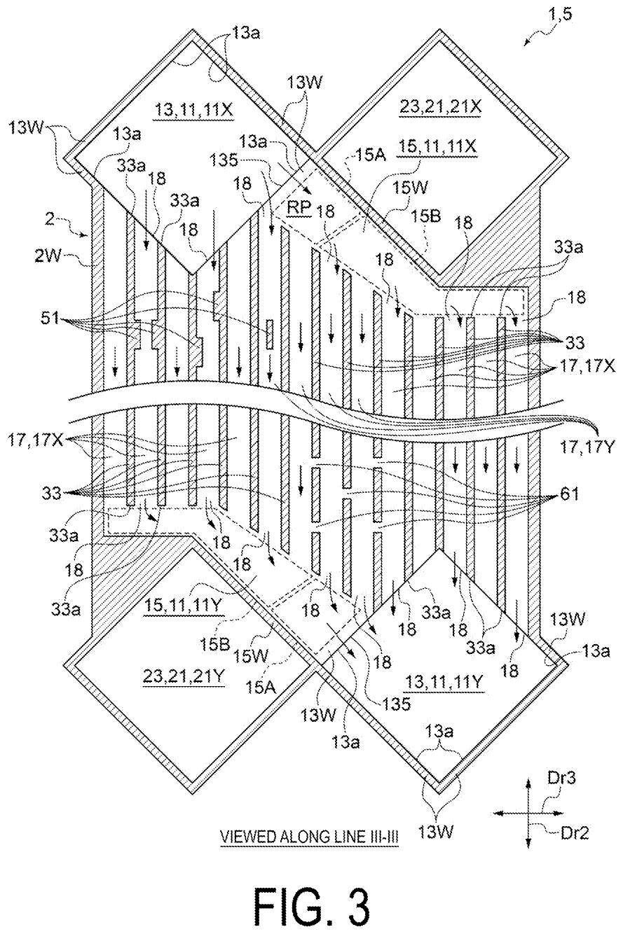

FIG. 3 is a cross-sectional view taken along line in FIG. 2.

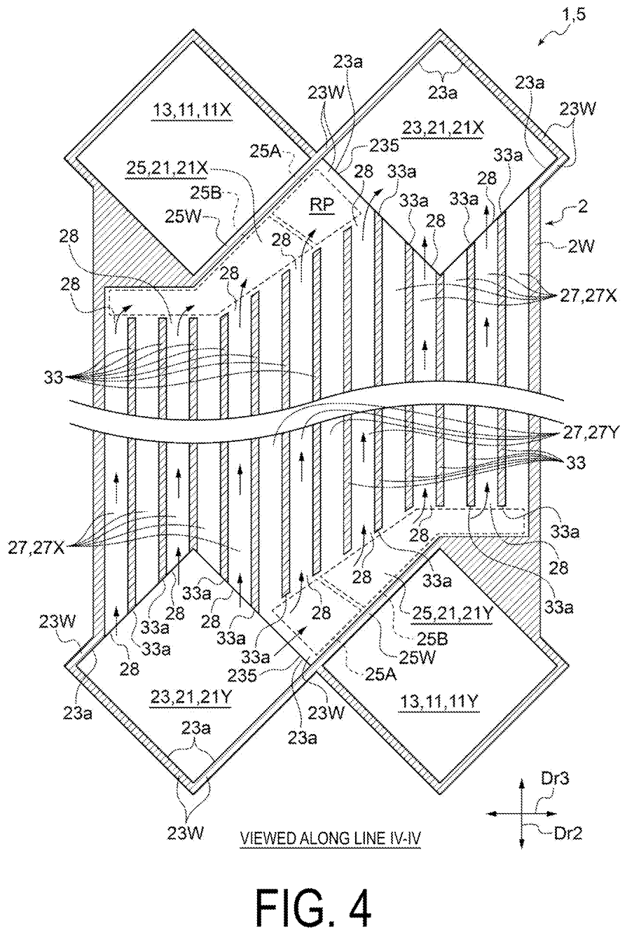

FIG. 4 is a cross-sectional view taken along line IV-IV in FIG. 2.

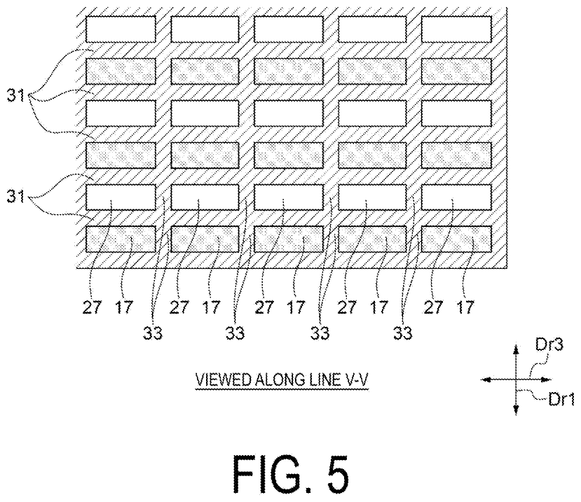

FIG. 5 is a cross-sectional view of a heat exchange core according to an embodiment taken along line V-V in FIG. 1.

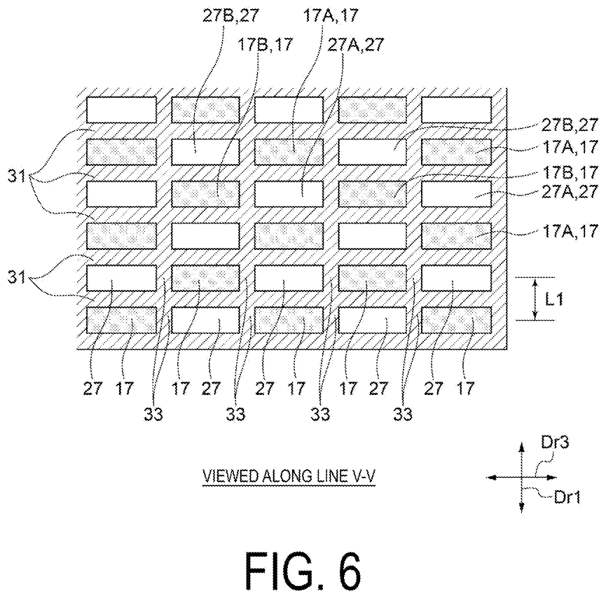

FIG. 6 is a cross-sectional view of a heat exchange core according to another embodiment taken along line V-V in FIG. 1.

The heat exchange core 1 illustrated in FIG. 1 is a heat exchange core 1 used in a heat exchanger 5 in which a first fluid and a second fluid exchange heat with each other.

The heat exchange core 1 according to some embodiments includes a plurality of first layers 10 and a plurality of second layers 20 inside a core housing 2. The plurality of first layers 10 include a plurality of first flow paths 17, and the plurality of second layers 20 include a plurality of second flow paths 27 and are disposed alternately with the first layers 10 in a layering direction.

The heat exchange core 1 according to some embodiments includes a first header 11 and a second header 21 inside the core housing 2. The first header 11 is connected to the plurality of first flow paths 17, and the second header 21 is connected to the plurality of second flow paths 27 and does not communicate with the first header 11.

In the heat exchange core 1 according to some embodiments, the first header 11 includes a first main header 13 extending in the layering direction and a first sub header 15 provided on each of the plurality of first layers 10 and connected to the first main header 13. In the heat exchange core 1 according to some embodiments, as described in detail below, some of the plurality of first flow paths 17 are connected to the first main header 13 at their end portions 18, and the rest of the plurality of first flow paths 17 are connected to the first sub header 15 at their end portions 18.

In the heat exchange core 1 according to some embodiments, the second header 21 includes a second main header 23 extending in the layering direction and a second sub header 25 provided on each of the plurality of second layers 20 and connected to the second main header 23. In the heat exchange core 1 according to some embodiments, as described in detail below, some of the plurality of second flow paths 27 are connected to the second main header 23 at their end portions 28, and the rest of the plurality of second flow paths 27 are connected to the second sub header 25 at their end portions 28.

Each of the first fluid and the second fluid may be a liquid or a gas, and usually they differ in temperature. In the heat exchange core 1, for example, the core housing 2 excluding the first header 11 and the second header 21 may have a cuboid shape, but not limited thereto.

The heat exchange core 1 illustrated in FIG. 1 may be used, for example, by being attached to a housing (not illustrated) of the heat exchanger 5. Alternatively, the heat exchange core 1 illustrated in FIG. 1 may be used by being installed on a frame or being supported by a pipe (not illustrated) connected to the heat exchange core 1, instead of being attached to the housing. In that case, the heat exchange core 1 illustrated in FIG. 1 itself is the heat exchanger 5.

In the heat exchange core 1 according to some embodiments, as described in detail below, for example, the first flow paths 17 located relatively close to the first main header 13 are preferably connected to the first main header 13 so that a fluid directly flows into and out of the first main header 13. This makes it possible to relatively reduce the distance between the first main header 13 and the first flow paths 17, reduce pressure loss, and downsize the heat exchange core 1.

On the other hand, the first flow paths 17 located relatively far from the first main header 13 are preferably connected to the first sub header 15 so that a fluid flows into and out of the first main header 13 via the first sub header 15. This makes it possible to reduce pressure loss as compared with the case where the first flow paths 17 are extended to the first main header 13, and thus to reduce the difference in the flow rate of a fluid from the first flow paths 17 located relatively close to the first main header 13 and directly connected to the first main header 13. Consequently, variations in flow rate in the plurality of first flow paths 17 are suppressed, and thus the pressure loss can be reduced and the heat exchange efficiency can be improved in the heat exchange core 1.

Thus, according to the heat exchange core 1 according to some embodiments, the heat exchange core 1 having excellent heat exchange efficiency can be provided.

Similarly, in the heat exchange core 1 according to some embodiments, as described in detail below, for example, the second flow paths 27 located relatively close to the second main header 23 are preferably connected to the second main header 23 so that a fluid directly flows into and out of the second main header 23. This makes it possible to relatively reduce the distance between the second main header 23 and the second flow paths 27, reduce pressure loss, and downsize the heat exchange core 1.

On the other hand, the second flow paths 27 located relatively far from the second main header 23 are preferably connected to the second sub header 25 so that a fluid flows into and out of the second main header 23 via the second sub header 25. This makes it possible to reduce pressure loss as compared with the case where the second flow paths 27 are extended to the second main header 23, and thus to reduce the difference in the flow rate of a fluid from the second flow paths 27 located relatively close to the second main header 23 and directly connected to the second main header 23. Consequently, variations in flow rate in the plurality of second flow paths 27 are suppressed, and thus the pressure loss can be reduced and the heat exchange efficiency can be improved in the heat exchange core 1.

Thus, according to the heat exchange core 1 according to some embodiments, the heat exchange core 1 having excellent heat exchange efficiency can be provided.

According to the heat exchanger 5 provided with the heat exchange core 1 according to some embodiments, the heat exchanger 5 having excellent heat exchange efficiency can be provided.

For convenience of description, each direction in the heat exchange core 1 according to some embodiments may be referred to as follows.

As described in detail below, in the heat exchange core 1 according to some embodiments, each of a plurality of the first sub headers 15 and each of a plurality of the second sub headers 25 are a layered header extending along a reference plane RP, and the first sub headers 15 and the second sub headers 25 are layered alternately with each other in a direction orthogonal to the reference plane RP. The direction orthogonal to the reference plane RP is also referred to as a layering direction of each of the layers 10, 20, or simply as a layering direction. For convenience of description, the direction orthogonal to the reference plane RP is also referred to as a first direction Dr1.

A direction which is included in the extending direction of the reference plane RP and is the extending direction of the plurality of first flow paths 17 and the plurality of second flow paths 27 is also referred to as a second direction Dr2.

A direction which is included in the extending direction of the reference plane RP and is orthogonal to the first direction Dr1 and the second direction Dr2 is also referred to as a third direction Dr3.

The first direction Dr1, the second direction Dr2, and the third direction Dr3 are orthogonal to each other.

First Header 11 and Second Header 21

In the heat exchange core 1 according to some embodiments, the first header 11 is formed on one end side and the other end side of the core housing 2 along the second direction Dr2. Similarly, in the heat exchange core 1 according to some embodiments, the second header 21 is formed on one end side and the other end side of the core housing 2 along the second direction Dr2.

In the heat exchange core 1 according to some embodiments, each of the first headers 11 formed on both end sides of the core housing 2 along the second direction Dr2 has a similar configuration. In the following, among the two first headers 11, the first header 11 illustrated in the upper parts of FIGS. 1 and 3 is mainly described and the description of the first header 11 illustrated in the lower parts is omitted.

Further, in the heat exchange core 1 according to some embodiments, each of the second headers 21 formed on both end sides of the core housing 2 along the second direction Dr2 has a similar configuration.

In the following, among the two second headers 21, the second header 21 illustrated in the upper parts of FIGS. 1 and 4 is mainly described and the description of the second header 21 illustrated in the lower parts is omitted.

First Main Header 13

In the heat exchange core 1 according to some embodiments, the first header 11 includes the first main header 13 extending in the first direction Dr1 and the first sub header 15 provided on each of the plurality of first layers 10, as described above.

The first main header 13 according to some embodiments is a header portion having a rectangular cross section when viewed from the first direction Dr1. One of the two diagonal lines of the rectangular cross section of the first main header 13 when viewed from the first direction Dr1 extends along the second direction Dr2, and the other diagonal line extends along the third direction Dr3. That is, when viewed from the layering direction (first direction Dr1), a wall portion 13W defining the first main header 13 includes an inclined surface 13a which is inclined with respect to the extending direction of the plurality of first flow paths 17 (the second direction Dr2) and inclined with respect to a direction (the third direction Dr3) orthogonal to the extending direction, in an in-plane direction of the first layer 10 (the extending direction of the reference plane RP).

In the heat exchange core 1 according to some embodiments, a first opening 113 is formed in each wall portion 2W of the core housing 2 facing the first direction Dr1 so as to enable the first main header 13 to communicate with the outside of the core housing 2. The first opening 113 is a communication port for circulating a fluid between the first main header 13 and an external space of the core housing 2. Note that the first opening 113 which is not used is closed by a lid (not illustrated).

Second Main Header 23

Similarly, in the heat exchange core 1 according to some embodiments, the second header 21 includes the second main header 23 extending in the first direction Dr1 and the second sub header 25 provided on each of the plurality of second layers 20, as described above.

The second main header 23 according to some embodiments is a header portion having a rectangular cross section when viewed from the first direction Dr1. One of the two diagonal lines of the rectangular cross section of the second main header 23 when viewed from the first direction Dr1 extends along the second direction Dr2, and the other diagonal line extends along the third direction Dr3. That is, when viewed from the layering direction (first direction Dr1), a wall portion 23W defining the second main header 23 has an inclined surface 23a which is inclined with respect to the extending direction of the plurality of second flow paths 27 (the second direction Dr2) and inclined with respect to a direction (the third direction Dr3) orthogonal to the extending direction, in an in-plane direction of the second layer 20 (the extending direction of the reference plane RP).

In the heat exchange core 1 according to some embodiments, a second opening 213 is formed in each wall portion 2W of the core housing 2 facing the first direction Dr1 so as to enable the second main header 23 to communicate with the outside of the core housing 2. The second opening 213 is a communication port for circulating a fluid between the second main header 23 and an external space of the core housing 2. Note that the second opening 213 which is not used is closed by a lid (not illustrated).

In the heat exchange core 1 according to some embodiments, the first main header 13 illustrated in the upper parts of FIGS. 1, 3, and 4 is disposed on one side (the left side in FIGS. 2, 3, and 4) along the third direction Dr3, and the second main header 23 illustrated in the upper parts is disposed on the other side (the right side in FIGS. 2, 3, and 4) along the third direction Dr3.

In the heat exchange core 1 according to some embodiments, the first main header 13 illustrated in the lower parts of FIGS. 1, 3, and 4 is disposed on one side (the right side in FIGS. 2, 3, and 4) along the third direction Dr3, and the second main header 23 illustrated in the lower parts is disposed on the other side (the left side in FIGS. 2, 3, and 4) along the third direction Dr3.

That is, in the heat exchange core 1 according to some embodiments, the first main header 13 illustrated in the upper parts and the first main header 13 illustrated in the lower parts of FIGS. 1, 3, and 4 are disposed on opposite sides along the third direction Dr3. Similarly, in the heat exchange core 1 according to some embodiments, the second main header 23 illustrated in upper parts and the second main header 23 illustrated in the lower parts of FIGS. 1, 3, and 4 are disposed on opposite sides along the third direction Dr3.

Note that, in the heat exchange core 1 according to some embodiments, the first main header 13 illustrated in the upper parts and the first main header 13 illustrated in the lower parts of FIGS. 1, 3, and 4 may be disposed on the same side along the third direction Dr3. Similarly, in the heat exchange core 1 according to some embodiments, the second main header 23 illustrated in the upper parts and the second main header 23 illustrated in the lower parts of FIGS. 1, 3, and 4 may be disposed on the same side along the third direction Dr3.

First Sub Header 15 and Second Sub Header 25

Each of the first sub header 15 according to some embodiments is a layered header extending along the reference plane RP which extends in the second direction Dr2 and the third direction Dr3.

Each of the second sub headers 25 according to some embodiments is a layered header extending along the reference plane RP.

Note that, in some embodiments, the reference plane RP is parallel to the paper planes of FIGS. 3 and 4.

Each of the first sub headers 15 according to some embodiments is layered in a direction orthogonal to the reference plane RP, that is, in the first direction Dr1.

Each of the second sub headers 25 according to some embodiments is layered in the first direction Dr1.

More specifically, in the heat exchange core 1 according to some embodiments, the first sub headers 15 and the second sub headers 25 are alternately layered in the first direction Dr1.

The first sub header 15 and the second sub header 25 adjacent to each other along the first direction Dr1 are separated from each other by an interlayer partition wall 31.

Note that adjacent interlayer partition walls 31 may be connected to each other by a rib (not illustrated) so as to reduce warping of the interlayer partition walls 31.

In some embodiments, each of the interlayer partition walls 31 is formed not only in a region where the first sub header 15 and the second sub header 25 are present, but also to a region where the first flow path 17 and the second flow path 27 are present along the second direction Dr2, so as to separate the first flow path 17 from the second flow path 27 adjacent to each other in the first direction Dr1.

When viewed from the first direction Dr1, each of the first sub headers 15 according to some embodiments is defined by the end portions 18 of the first flow paths 17 connected to the first sub header 15 and a roof wall portion 15W formed separated from the end portions 18 along the second direction Dr2. Note that the first flow paths 17 adjacent to each other along the third direction Dr3 are separated from each other by a flow path partition wall 33. The end portion 18 of the first flow path 17 is formed by end portions 33a of two flow path partition walls 33 sandwiching the first flow path 17.

Each of the first sub headers 15 according to some embodiments includes an opening end 135 facing the first main header 13. Each of the first sub headers 15 according to some embodiments communicates with the first main header 13 via the opening end 135.

In each of the first sub headers 15 according to some embodiments, in at least a region on the side of the first main header 13, the distance between the end portions 18 of the first flow paths 17 connected to the first sub header 15 and the roof wall portion 15W decreases with an increasing distance from the first main header 13.

For example, when a fluid flows from the first sub header 15 to the first flow paths 17, the flow rate of the fluid flowing through the first sub header 15 decreases with an increasing distance from the first main header 13. On the other hand, when a fluid flows from the first flow paths 17 to the first sub header 15, the flow rate of the fluid flowing through the first sub header 15 increases with a decreasing distance to the first main header 13. By configuring the distance between the end portions 18 of the first flow paths 17 and the roof wall portion 15W as described above, the cross-sectional area of the flow path in the first sub header 15 decreases with an increasing distance from the first main header 13. This makes it possible to reduce differences in flow velocity of a fluid due to positional differences in the first sub header 15 in the third direction Dr3, and to suppress variations in flow rate between the first flow paths 17 connected to the first sub header 15.

Similarly, when viewed from the first direction Dr1, each of the second sub headers 25 according to some embodiments is defined by the end portions 28 of the second flow paths 27 connected to the second sub header 25 and a roof wall portion 25W formed separated from the end portions 28 along the second direction Dr2. Note that the second flow paths 27 adjacent to each other along the third direction Dr3 are separated from each other by the flow path partition wall 33. The end portion 28 of the second flow path 27 is formed by the end portions 33a of two flow path partition walls 33 sandwiching the second flow path 27.

Each of the second sub headers 25 according to some embodiments includes an opening end 235 facing the second main header 23. Each of the second sub headers 25 according to some embodiments communicates with the second main header 23 via the opening end 235.

In each of the second sub headers 25 according to some embodiments, in at least a region on the side of the second main header 23, the distance between the end portions 28 of the second flow paths 27 connected to the second sub header 25 and a roof wall portion 25W decreases with an increasing distance from the second main header 23.

By configuring the distance between the end portions 28 of the second flow paths 27 and the roof wall portion 25W as described above, the cross-sectional area of the flow path in the second sub header 25 decreases with an increasing distance from the second main header 23.

This makes it possible to reduce differences in flow velocity of a fluid due to positional differences in the second sub header 25 in the third direction Dr3, and to suppress variations in flow rate between the second flow paths 27 connected to the second sub header 25.

As illustrated in FIGS. 3 and 4, in a region of the first sub header 15 on the side opposite to the first main header 13, the distance between the end portions 18 of the first flow paths 17 and the roof wall portion 15W may be constant regardless of positions in the third direction Dr3. Meanwhile, in the region described above, the distance may decrease with an increasing distance from the first main header 13.

Similarly, as illustrated in FIGS. 3 and 4, in a region of the second sub header 25 on the side opposite to the second main header 23, the distance between the end portions 28 of the second flow paths 27 and the roof wall portion 25W may be constant regardless of positions in the third direction Dr3. Meanwhile, in the region described above, the distance may decrease with an increasing distance from the second main header 23.

As illustrated in FIG. 3, when viewed from the first direction Dr1, at least a part of the roof wall portion 15W defining the first sub header 15 is positioned in a direction along which the roof wall portion 15W becomes closer to the end portions 18 along the extending direction as distance between the roof wall portion 15W and the first main header 13 increases along a direction (the third direction Dr3) orthogonal to an extending direction of the plurality of first flow paths 17 in an in-plane direction of the first layer.

Thus, at least some of the roof wall portion 15W is inclined with respect to the second direction Dr2. For example, in the case where the heat exchange core 1 is formed by an additive manufacturing method and the second direction Dr2 is defined as a layering direction in the additive manufacturing, the roof wall portion 15W as an overhang portion is inclined with respect to the layering direction in the additive manufacturing. Thus, the roof wall portion 15W can be formed without forming a support portion for the additive manufacturing.

Similarly, as illustrated in FIG. 4, when viewed from the first direction Dr1, at least a part of the roof wall portion 25W defining the second sub header 25 is positioned in a direction in which the roof wall portion 15W becomes closer to the end portions 28 along the second direction Dr2 as distance between the roof wall portion 15W and the second main header 23 increases along the third direction Dr3.

Thus, at least some of the roof wall portion 25W are inclined with respect to the second direction Dr2. Accordingly, for example, in the case where the heat exchange core 1 is formed by an additive manufacturing method and the second direction Dr2 is defined as a layering direction in the additive manufacturing, the roof wall portion 25W can be formed without forming a support portion.

As illustrated in FIG. 3, when viewed from the first direction Dr1, at least some of the end portions 18 of the first flow paths 17 connected to the first sub header 15 are positioned along a direction in which the end portions 18 become further away from the roof wall portion 15W along the second direction Dr2 as distance between the end portions 18 and the first main header 13 increases along the third direction Dr3.

Thus, by appropriately setting the distance between the end portions 18 and the roof wall portion 15W, the cross-sectional area of the flow path in the first sub header 15 can be appropriately set so as to suppress variations in flow rate between the first flow paths 17 connected to the first sub header 15.

Similarly, as illustrated in FIG. 4, when viewed from the first direction Dr1, at least some of the end portions 28 of the second flow paths 27 connected to the second sub header 25 are positioned along a direction in which the end portions 28 become further away from the roof wall portion 25W along the second direction Dr2 as distance between the end portions 28 and the second main header 23 increases along the third direction Dr3.

Thus, by appropriately setting the distance between the end portions 28 and the roof wall portion 25W, the cross-sectional area of the flow path in the second sub header 25 can be appropriately set so as to suppress variations in flow rate between the second flow paths 27 connected to the second sub header 25.

When viewed from the first direction Dr1, the first sub header 15 illustrated in FIG. 3 overlaps with the second sub header 25 adjacent thereto in the first direction Dr1, in a region 15A which is relatively close to the first main header 13 and surrounded by dashed lines in FIG. 3.

When viewed from the first direction Dr1, the first sub header 15 illustrated in FIG. 3 overlaps with the second flow path 27 adjacent thereto in the first direction Dr1, in a region 15B which is relatively far from the first main header 13 and surrounded by dashed lines in FIG. 3.

Similarly, when viewed from the first direction Dr1, the second sub header 25 illustrated in FIG. 4 overlaps with the first sub header 15 adjacent thereto in the first direction Dr1, in a region 25A which is relatively close to the second main header 23 and surrounded by dashed lines in FIG. 4.

When viewed from the first direction Dr1, the second sub header 25 illustrated in FIG. 4 overlaps with the first flow path 17 adjacent thereto in the first direction Dr1, in a region 25B which relatively far from the second main header 23 and surrounded by dashed lines in FIG. 4.

As illustrated in FIG. 3, the first sub header 15 is preferably adjacent to the second main header 23 with the roof wall portion 15W interposed between the first sub header 15 and the second main header 23.

This enables the first sub header 15 and the second main header 23 to come close to each other, and thus the heat exchange core 1 can be downsized.

Similarly, as illustrated in FIG. 4, the second sub header 25 is preferably adjacent to the first main header 13 with the roof wall portion 25W interposed between the second sub header 25 and the first main header 13.

This enables the second sub header 25 and the first main header 13 to come close to each other, and thus the heat exchange core 1 can be downsized.

First Flow Path 17 and Second Flow Path 27

As illustrated in FIGS. 2 and 3, each of the first flow paths 17 according to some embodiments is a flow path communicating with the first main header 13 or any of the first sub headers 15 via the respective end portions 18. Each of the first flow paths 17 according to some embodiments extends along the second direction Dr2.

As illustrated in FIGS. 2 and 4, each of the second flow paths 27 according to some embodiments is a flow path communicating with the second main header 23 or any of the second sub headers 25 via the respective end portions 28.

Each of the second flow paths 27 according to some embodiments extends along the second direction Dr2.

In some embodiments, the first flow paths 17 adjacent to each other along the third direction Dr3 are separated from each other by the flow path partition wall 33. Similarly, in some embodiments, the second flow paths 27 adjacent to each other along the third direction Dr3 are separated from each other by the flow path partition wall 33.

In some embodiments, the first flow path 17 and the second flow path 27 are adjacent to each other along the first direction Dr1. As described above, in some embodiments, the first flow path 17 and the second flow path 27 are separated from each other by the interlayer partition wall 31 along the first direction Dr1.

That is, in some embodiments, the first flow path 17 and the second flow path 27 are defined by the flow path partition wall 33 and the interlayer partition wall 31.

As illustrated in FIG. 3, each of the first flow paths 17 according to some embodiments includes two types of an outer first flow path 17X: a first type connected to the first main header 13 at its end portion 18 on one side in the second direction Dr2 (for example, in the upper part of FIG. 3) and to the first sub header 15 at its end portion 18 on the other side (for example, in the lower part of FIG. 3); and a second type connected to the first sub header 15 at its end portion 18 on one side in the second direction Dr2 and to the first main header 13 at its end portion 18 on the other side. Further, as illustrated in FIG. 3, each of the first flow paths 17 according to some embodiments includes an inner first flow path 17Y which is connected to the first sub header 15 at its end portion 18 on one side in the second direction Dr2 and to the first sub header 15 at its end portion 18 on the other side.

Similarly, as illustrated in FIG. 4, each of the second flow paths 27 according to some embodiments includes two types of an outer second flow path 27X: one type connected to the second main header 23 at its end portion 28 on one side in the second direction Dr2 (for example, in the upper part of FIG. 4) and to the second sub header 25 at its end portion 28 on the other side (for example, in the lower part of FIG. 4); and the other type connected to the second sub header 25 at its end portion 28 on one side in the second direction Dr2 and to the second main header 23 at its end portion 28 on the other side. Further, as illustrated in FIG. 4, each of the second flow paths 27 according to some embodiments includes an inner second flow path 27Y which is connected to the second sub header 25 at its end portion 28 on one side in the second direction Dr2 and to the second sub header 25 at its end portion 28 on the other side.

The position of the end portion 33a of the flow path partition wall 33 in the second direction Dr2 is set to substantially coincide with the position of the inclined surface 13a or the inclined surface 23a when the end portion 33a faces the first main header 13 or the second main header 23.

The position of the end portion 33a of the flow path partition wall 33 in the second direction Dr2 is set to match the shape of the first sub header 15 or the second sub header 25 when the end portion 33a faces the first sub header 15 or the second sub header 25.

As illustrated in FIGS. 5 and 6, in some embodiments, each of the first flow paths 17 and each of the second flow paths 27 have a rectangular flow path shape in a cross section orthogonal to the second direction Dr2, and each of the first flow paths 17 and each of the second flow paths 27 are identical in shape. In some embodiments, each of the first flow paths 17 and each of the second flow paths 27 have a dimension in the third direction Dr3 greater than a dimension in the first direction Dr1. However, the dimension in the third direction Dr3 may be identical to the dimension in the first direction Dr1, or the dimension in the third direction Dr3 may be smaller than the dimension in the first direction Dr1.

Further, each of the first flow paths 17 and each of the second flow paths 27 may have a flow path shape other than the rectangular flow path shape described above.

As illustrated FIGS. 5 and 6, in some embodiments, the first flow paths 17 and the second flow paths 27 are disposed so as to align along the third direction Dr3 and the first direction Dr1. As illustrated in FIGS. 5 and 6, in some embodiments, the first flow paths 17 and the second flow paths 27 are alternately disposed along the first direction Dr1.

As illustrated in FIG. 5, in the heat exchange core 1 according to an embodiment, flow path rows, each consisting of the plurality of first flow paths 17 disposed along the third direction Dr3, and flow path rows, each consisting of the plurality of second flow paths 27 disposed along the third direction Dr3, are disposed alternately along the first direction Dr1.

As illustrated in FIG. 6, in the heat exchange core 1 according to another embodiment, the first flow paths 17 and the second flow paths 27 may be alternately disposed along the third direction Dr3. Specifically, as illustrated in FIG. 6, in the heat exchange core 1 according to another embodiment, the first flow paths 17 and the second flow paths 27 may form a checkerboard pattern in a cross section orthogonal to the second direction Dr2. That is, the first flow paths 17 and the second flow paths 27 are preferably configured so that at least some of the plurality of first flow paths 17 overlap along the first direction Dr1 at least some of the second flow paths 27 disposed on at least either of one side or the other side along the third direction Dr3.

A configuration in which the first flow paths 17 and the second flow paths 27 form a checkerboard pattern in a cross section orthogonal to the second direction Dr2 will be described later.

As illustrated in FIGS. 5 and 6, in some embodiments, two flow paths 17, 27 adjacent to each other along the third direction Dr3 face each other at their short sides in the rectangular shapes described above with the flow path partition wall 33 interposed between them. As illustrated in FIGS. 5 and 6, in some embodiments, two flow paths 17, 27 adjacent to each other along the first direction Dr1 face each other at their long sides in the rectangular shapes described above with the interlayer partition wall 31 interposed between them.

Further, for example, as exemplified in FIG. 3, at least some of the plurality of first flow paths 17 may have a plurality of protruding portions 51 which are formed so as to protrude from wall surfaces defining the first flow paths 17, that is, the wall surfaces of the flow path partition walls 33 or the interlayer partition walls 31, into the first flow paths 17.

FIG. 3 only illustrates an example of the shape of the protruding portions 51 and is not intended to limit positions where the protruding portions 51 are formed. That is, although FIG. 3 illustrates an example where only one or two protruding portions are formed in one first flow path 17, they may be formed at many more positions along the extending direction of the first flow path 17.

For example, the protruding portions 51 may be formed at the same positions in the second direction on the two flow path partition walls 33 sandwiching one first flow path 17, or may be alternately formed along the second direction. Further, for example, the protruding portions 51 may be formed so as to protrude from the interlayer partition wall 31 between two flow path partition walls 33 sandwiching one first flow path 17 with a space from the two flow path partition walls 33.

Consequently, the flow of a fluid is appropriately disturbed by the protruding portions 51 and thus the development of a boundary layer in the flow path partition wall 33 and the interlayer partition wall 31 is suppressed. This increases heat transfer coefficient between the fluid and the flow path partition wall 33 and the interlayer partition wall 31 defining the first flow paths 17 and improves heat exchange efficiency.

Although illustration and detailed description are omitted, at least some of the plurality of second flow paths 27 may have a plurality of protruding portions which are formed so as to protrude from wall surfaces defining the second flow path 27, that is, the wall surfaces of the flow path partition walls 33 or the interlayer partition walls 31, into the second flow paths 27 in the same manner as the protruding portions 51 in the first flow paths 17.

Further, for example, as exemplified in FIG. 3, at least some of the plurality of first flow paths 17 may have a plurality of communicating portions 61 in the flow path partition wall 33 separating two first flow paths 17 adjacent to each other in the first layer 10 so as to enable the two first flow paths 17 to communicate with each other.

The communicating portions 61 are preferably provided at a plurality of positions in a plurality of flow path partition walls 33.

Accordingly, for example, when a first flow path 17 gets clogged with a foreign matter, a fluid flowing from the upstream of a clogged portion may flow into another first flow path 17 via the communicating portion 61. Thus, the decrease in heat exchange efficiency due to the clogging of the first flow path 17 can be suppressed. Further, by providing a number of the communicating portions 61, the flow of a fluid is appropriately disturbed and thus the development of a boundary layer in the wall surfaces of the flow path partition wall 33 and the interlayer partition wall 31 is suppressed. This increases heat transfer coefficient between the fluid and the flow path partition wall 33 and the interlayer partition wall 31 defining the first flow path 17 and improves heat exchange efficiency.

Flow of Fluid

In the heat exchange core 1 according to some embodiments described above, the first fluid and the second fluid circulate inside the heat exchange core 1 as described below. For convenience of description, the first fluid flows into the first header 11 illustrated in the upper parts of FIGS. 1, 3, and 4. On the other hand, the second fluid flows into the second header 21 illustrated in the lower parts of FIGS. 1, 3, and 4. In that case, the flows of the first fluid and the second fluid inside the heat exchange core 1 are counter flows as described below.

Flow of First Fluid

The first fluid flows from the first opening 113 formed in the upper part of the core housing 2 illustrated in the upper part of FIG. 1 into the first main header 13 of the first header 11 illustrated in the upper parts of FIGS. 1, 3, and 4.

Some of the first fluid which has flowed into the first main header 13 flows into each of the first flow paths 17 connected to the first main header 13. The remainder of the first fluid which has flowed into the first main header 13 flows from each of the opening ends 135 facing the first main header 13 into each of the first sub headers 15 illustrated in the upper part of FIG. 3. That is, the remainder of the first fluid which has flowed into the first main header 13 is distributed to each of the first sub headers 15.

The first fluid which has flowed into each of the first sub headers 15 flows from each of the end portions 18 illustrated in the upper part of FIG. 3 into each of the first flow paths 17 in each of the first sub headers 15. That is, the first fluid which has flowed into each of the first sub headers 15 is further distributed to each of the first flow paths 17.

The first fluid which has flowed into each of the first flow paths 17 flows through each of the first flow paths 17 toward the lower part of FIG. 3, and flows from each of the end portions 18 illustrated in the lower part of FIG. 3 into the first main header 13 or each of the first sub headers 15 illustrated in the lower part of FIG. 3. Further, the first fluid which has flowed into each of the first sub headers 15 flows from each of the opening ends 135 facing the first main header 13 illustrated in the lower part of FIG. 3 into the first main header 13.

The first fluid which has flowed into the first main header 13 flows outward from any of the first openings 113 formed in the lower part of the core housing 2 illustrated in the lower part of FIG. 1.

Flow of Second Fluid

The second fluid flows from the second opening 213 formed in the lower part of the core housing 2 illustrated in the lower part of FIG. 1 into the second main header 23 of the second header 21 illustrated in the lower parts of FIGS. 1, 3, and 4.

Some of the second fluid which has flowed into the second main header 23 flows into each of the second flow paths 27 connected to the second main header 23. The remainder of the second fluid which has flowed into the second main header 23 flows from each of the opening ends 235 facing the second main header 23 into each of the second sub headers 25 illustrated in the lower part of FIG. 4. That is, the remainder of the second fluid which has flowed into the second main header 23 is distributed to each of the second sub headers 25.

The second fluid which has flowed into each of the second sub headers 25 flows from each of the end portions 28 illustrated in the lower part of FIG. 4 into each of the second flow paths 27 in each of the second sub headers 25. That is, the second fluid which has flowed into each of the second sub headers 25 is further distributed to each of the second flow paths 27.

The second fluid which has flowed into each of the second flow paths 27 flows through each of the second flow paths 27 toward the upper part of FIG. 4, and flows from each of the end portions 28 illustrated in the upper part of FIG. 4 into the second main header 23 or each of the second sub headers 25 illustrated in the upper part of FIG. 4. Further, the second fluid which has flowed into each of the second sub headers 25 flows from each of the opening ends 235 facing the second main header 23 illustrated in the upper part of FIG. 4 into the second main header 23.

The second fluid which has flowed into the second main header 23 flows outward from any of the second openings 213 formed in the upper part of the core housing 2 illustrated in the upper part of FIG. 1.

Note that, when the second fluid flows into the second header 21 illustrated in the upper parts of FIGS. 1, 3, and 4, the flows of the first fluid and the second fluid inside the heat exchange core 1 are parallel flows.

Heat Exchange in Heat Exchange Core 1

In the heat exchange core 1 according to some embodiments, the first fluid flowing through each of the first flow paths 17 toward the lower parts of FIGS. 1, 3, and 4 and the second fluid flowing through each of the second flow paths 27 toward the upper parts of FIGS. 1, 3, and 4 exchange heat with each other via the interlayer partition wall 31. Further, in the heat exchange core 1 according to another embodiment illustrated in FIG. 6, the first fluid flowing through each of the first flow paths 17 toward the lower parts of FIGS. 1, 3, and 4 and the second fluid flowing through each of the second flow paths 27 toward the upper parts of FIGS. 1, 3, and 4 also exchange heat with each other via the flow path partition wall 33.

Moreover, in the heat exchange core 1 according to some embodiments, the first fluid flowing through each of the first sub headers 15 exchanges heat with the second fluid flowing through each of the second sub headers 25 and with the second fluid flowing through each of the second flow paths 27 via the interlayer partition wall 31 in the regions 15A and 15B described above.

Similarly, in the heat exchange core 1 according to some embodiments, the second fluid flowing through each of the second sub headers 25 exchanges heat with the first fluid flowing through each of the first sub headers 15 and with the first fluid flowing through each of the first flow paths 17 via the interlayer partition wall 31 in the regions 25A and 25B described above.

According to the heat exchange core 1 according to some embodiments described above, it is possible to further accomplish the following operational effects.

For example, in the heat exchange core 1 according to some embodiments, the first header 11 preferably includes: a one side first header 11X connected to the end portions 18 on one side of the plurality of first flow paths 17 (for example, the first header 11 illustrated in the upper part of FIG. 1); and an other side first header 11Y connected to the end portions 18 on the other side of the plurality of first flow paths 17 (for example, the first header 11 illustrated in the lower part of FIG. 1). The other side first header 11Y is disposed on the opposite side of the one side first header 11X in a direction (the third direction Dr3) orthogonal to the extending direction of the plurality of first flow paths 17 (the second direction Dr2) in the in-plane direction of the first layer 10.

Similarly, in the heat exchange core 1 according to some embodiments, the second header 21 preferably includes: a one side second header 21X connected to the end portions 28 on one side of the plurality of second flow paths 27 (for example, the second header 21 illustrated in the upper part of FIG. 1); and an other side second header 21Y connected to the end portions 28 on the other side of the plurality of second flow paths 27 (for example, the second header 21 illustrated in the lower part of FIG. 1). The other side second header 21Y is disposed on the opposite side of the one side second header 21X in a direction (the third direction Dr3) orthogonal to the extending direction of the plurality of second flow paths 27 (the second direction Dr2) in the in-plane direction of the second layer 20.

Consequently, as compared with the case where the other side first header 11Y is disposed at substantially the same position as the one side first header 11X in the third direction Dr3, the difference in pressure loss between the plurality of first flow paths 17 can be reduced and thus the difference in flow rate between the plurality of first flow paths 17 can be reduced. This makes it possible to reduce the pressure loss and improve the heat exchange efficiency in the heat exchange core 1.

Similarly, as compared with the case where the other side second header 21Y is disposed at substantially the same position as the one side second header 21X in the third direction Dr3, the difference in pressure loss between the plurality of second flow paths 27 can be reduced and thus the difference in flow rate between the plurality of second flow paths 27 can be reduced. This makes it possible to reduce the pressure loss and improve the heat exchange efficiency in the heat exchange core 1.

For example, in the heat exchange core 1 according to some embodiments, among the plurality of first flow paths 17, the first flow paths 17 which are connected to the first main header 13 in the one side first header 11X at their end portions 18 on one side (for example, the end portions 18 illustrated in the upper part of FIG. 3) are connected to the first sub header 15 in the other side first header 11Y at their end portions 18 on the other side (for example, the end portions 18 illustrated in the lower part of FIG. 3). Among the plurality of first flow paths 17, the first flow paths 17 which are connected to the first main header 13 in the other side first header 11Y at their end portions 18 on the other side are connected to the first sub header 15 in the one side first header 11X at their end portions 18 on one side.

Similarly, in the heat exchange core 1 according to some embodiments, among the plurality of second flow paths 27, the second flow paths 27 which are connected to the second main header 23 in the one side second header 21X at their end portions 28 on one side (for example, the end portions 28 illustrated in the upper part of FIG. 4) are connected to the second sub header 25 in the other side second header 21Y at their end portions 28 on the other side (for example, the end portions 28 illustrated in the lower part of FIG. 4). Among the plurality of second flow paths 27, the second flow paths 27 which are connected to the second main header 23 in the other side second header 21Y at their end portions 28 on the other side are connected to the second sub header 25 in the one side second header 21X at their end portions 28 on one side.

This allows the reduction of the difference in flow rate between the first flow paths 17 connected to the first main header 13 in the one side first header 11X at their end portions 18 on one side and the first flow paths 17 connected to the first main header 13 in the other side first header 11Y at their end portions 18 on the other side, among the plurality of first flow paths 17.

Similarly, it is possible to reduce the difference in flow rate between the second flow paths 27 connected to the second main header 23 in the one side second header 21X at their end portions 28 on one side and the second flow paths 27 connected to the second main header 23 in the other side second header 21Y at their end portions 28 on the other side, among the plurality of second flow paths 27.

For example, in the heat exchange core 1 according to some embodiments, the wall portion 13W defining the first main header 13 includes the inclined surface 13a described above, and the wall portion 23W defining the second main header 23 includes the inclined surface 23a described above.

Thus, the wall portion 13W defining the first main header 13 is inclined with respect to the extending direction of the plurality of first flow paths 17 (second direction Dr2). For example, in the case where the heat exchange core 1 is formed by an additive manufacturing method and the extending direction of the first flow path 17 (the second direction Dr2) is defined as a layering direction in the additive manufacturing, the wall portion 13W as an overhang portion is inclined with respect to the layering direction in the additive manufacturing. Thus, the wall portion 13W can be formed without forming a support portion for the additive manufacturing.

Similarly, the wall portion 23W defining the second main header 23 is inclined with respect to the extending direction of the plurality of second flow paths 27 (the second direction Dr2). For example, in the case where the heat exchange core 1 is formed by an additive manufacturing method and the extending direction of the second flow path 27 (the second direction Dr2) is defined as a layering direction in the additive manufacturing, the wall portion 23W as an overhang portion is inclined with respect to the layering direction in the additive manufacturing. Thus, the wall portion 23W can be formed without forming a support portion for the additive manufacturing.

For example, in the heat exchange core 1 according to some embodiments, at least some of the wall portion 13W defining the first main header 13 preferably protrude toward the opposite side of the plurality of first flow paths 17 along the extending direction of the plurality of first flow paths 17 (the second direction Dr2).

Similarly, in the heat exchange core 1 according to some embodiments, at least some of the wall portion 23W defining the second main header 23 preferably protrude toward the opposite side of the plurality of second flow paths 27 along the extending direction of the plurality of second flow paths 27 (the second direction Dr2).

When the first main header 13 is disposed near the end portion of the heat exchange core 1 along the extending direction of the plurality of first flow paths 17 (the second direction Dr2), and when the heat exchange core 1 is designed so as not to unnecessarily increase the wall thickness of the wall portion 13W defining the first main header 13, at least some of the wall portion 13W defining the first main header 13 protrude toward the opposite side of the plurality of first flow paths 17 along the second direction Dr2.

That is, for example, in the first main header 13 as illustrated in the upper parts of FIGS. 1, 3, and 4, when the heat exchange core 1 is designed so as not to unnecessarily increase the wall thickness of the wall portion 13W, the wall portion 13W protrudes toward the upper parts of FIGS. 1. 3, and 4.

For example, in the first main header 13 as illustrated in the lower parts of FIGS. 1, 3, and 4, when the heat exchange core 1 is designed so as not to unnecessarily increase the wall thickness of the wall portion 13W, the wall portion 13W protrudes toward the lower parts of FIGS. 1, 3, and 4.

Similarly, for example, in the second main header 23 as illustrated in the upper parts of FIGS. 1, 3, and 4, when the heat exchange core 1 is designed so as not to unnecessarily increase the wall thickness of the wall portion 23W, the wall portion 23W protrudes toward the upper parts of FIGS. 1, 3, and 4.

For example, in the second main header 23 as illustrated in the lower parts of FIGS. 1, 3, and 4, when the heat exchange core 1 is designed so as not to unnecessarily increase the wall thickness of the wall portion 23W, the wall portion 23W protrudes toward the lower parts of FIGS. 1, 3, and 4.

Thus, according to the heat exchange core 1 according to some embodiments, the weight of the heat exchange core 1 can be reduced. Note that, in the case where the heat exchange core 1 is formed by an additive manufacturing method, the time required for material and manufacturing can be reduced by reducing the weight of the heat exchange core 1, allowing reduction of manufacturing cost.

In the heat exchange core 1 according to some embodiments, for example as illustrated in FIG. 6, at least some of the plurality of first flow paths 17 preferably overlap along the first direction Dr1 at least some of the second flow path 27 disposed on at least either of the one side or the other side along the third direction Dr3.

This allows heat to easily transfer between the first flow path 17 and the second flow path 27 and facilitates heat exchange between a fluid flowing through the first flow path 17 and a fluid flowing through the second flow path 27 in a region where the first flow path 17 and the second flow path 27 overlap with each other along the first direction Dr1. Thus, heat exchange efficiency can be improved.

Flow Path Configuration in Checkerboard Pattern

The following is a description of a configuration in which the first flow paths 17 and the second flow paths 27 form a checkerboard pattern in a cross section orthogonal to the second direction Dr2 in the heat exchange core 1 according to another embodiment described above.

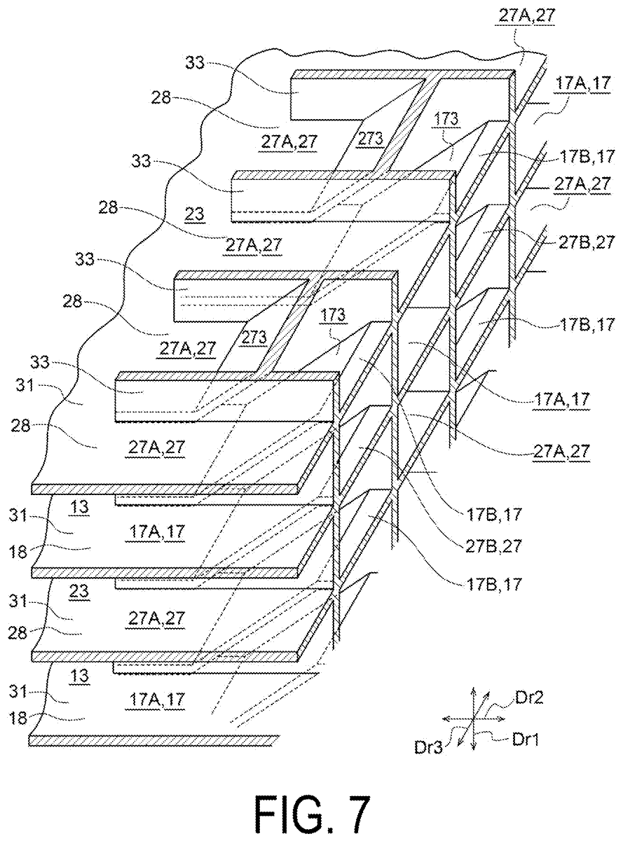

FIG. 7 is a schematic perspective cross-sectional view of a region from the first main header 13 or the first sub header 15 to the first flow paths 17 and a region from the second main header 23 or the second sub header 25 to the second flow paths 27. In FIG. 7, a cross section obtained by cutting non-offset flow paths 17A and 27A to be described later along the second direction Dr2 is illustrated on the front side.

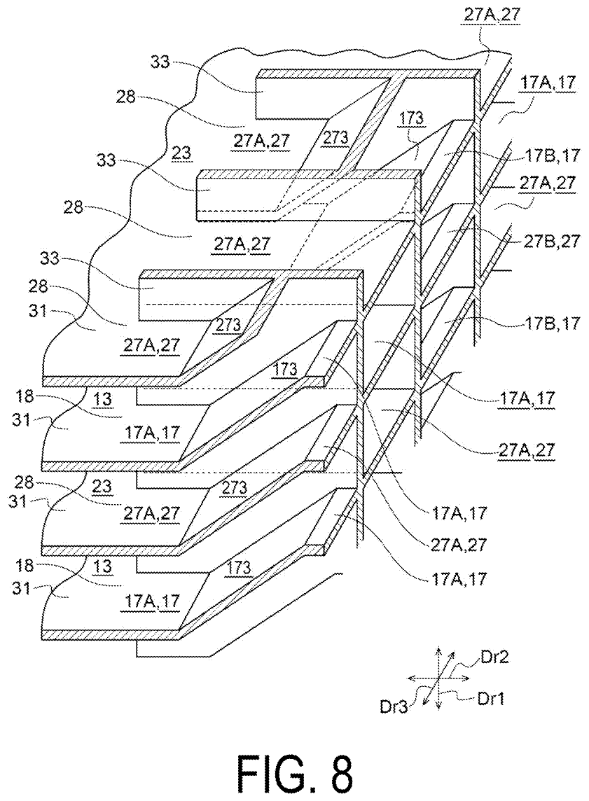

FIG. 8 is a schematic perspective cross-sectional view of a region from the first main header 13 or the first sub header 15 to the first flow paths 17 and a region from the second main header 23 or the second sub header 25 to the second flow paths 27. In FIG. 8, a cross section obtained by cutting offset flow paths 17B and 27B to be described later along the second direction Dr2 is illustrated on the front side.

For convenience of description, all the positions of the end portions 18 of the first flow paths 17 and the end portions 28 of the second flow paths 27 in the second direction Dr2 are the same in FIGS. 7 and 8.

In the heat exchange core 1 according to another embodiment, the first flow path 17 which is disposed at a position shifted in the first direction Dr1 with respect to the end portion 18 connected to the first main header 13 or the first sub header 15 includes a first transition section 173, the position of which is formed so as to gradually shift with respect to the end portion 18 in the first direction Dr1, from the end portion 18 toward the first flow path 17.

Similarly, in the heat exchange core 1 according to another embodiment, the second flow path 27 which is disposed at a position shifted in the first direction Dr1 with respect to the end portion 28 connected to the second main header 23 or the second sub header 25 includes a second transition section 273, the position of which is formed so as to gradually shift with respect to the end portion 28 in the first direction Dr1, from the end portion 28 toward the second flow path 27.

In the following description, among the plurality of first flow paths 17, the first flow path 17 disposed at a position shifted in the first direction Dr1 with respect to the end portion 18 is also referred to as an offset first flow path 17B, and the first flow path 17 disposed at a position not shifted in the first direction Dr1 with respect to the end portion 18 is also referred to as a non-offset first flow path 17A.

Further, among the plurality of second flow paths 27, the second flow path 27 disposed at a position shifted in the first direction Dr1 with respect to the end portion 28 is also referred to as an offset second flow path 27B, and the second flow path 27 disposed at a position not shifted in the first direction Dr1 with respect to the end portion 28 is also referred to as a non-offset second flow path 27A.

Note that, when the non-offset first flow path 17A and the non-offset second flow path 27A are not particularly distinguished from each other, they are also simply referred to as non-offset flow paths 17A, 27A. Similarly, when the offset first flow path 17B and the offset second flow path 27B are not particularly distinguished from each other, they are also simply referred to as offset flow paths 17B, 27B.

Moreover, when the first transition section 173 and the second transition section 273 are not particularly distinguished from each other, they are also simply referred to as transition sections 173, 273.

That is, in the heat exchange core 1 according to another embodiment, the offset first flow path 17B includes the first transition section 173, and the offset second flow path 27B includes the second transition section 273.

Note that, the non-offset first flow path 17A includes: the first flow path 17 which is not shifted in the first direction Dr1 from one end portion 18 to the other end portion 18 with respect to its own end portion 18; and a section which is not shifted in the first direction Dr1 with respect to its own end portion 18 in the first flow path 17 connected to the offset first flow path 17B.

The offset first flow path 17B includes: a section located in a position shifted in the first direction Dr1 with respect to its own end portion 18; and the first transition section 173, of the first flow path 17.

The non-offset second flow path 27A includes: the second flow path 27 which is not shifted in the first direction Dr1 from one end portion 28 to the other end portion 28 with respect to its own end portion 28; and a section which is not shifted in the first direction Dr1 with respect to its own end portion 28 in the second flow path 27 connected to the offset second flow path 27B.

The offset second flow path 27B includes: a section located in a position shifted in the first direction Dr1 with respect to its own end portion 28; and the second transition section 273, of the second flow path 27.

That is, in the heat exchange core 1 according to another embodiment, the first flow path 17 includes two types of flow paths: one type composed of the non-offset first flow path 17A only; and the other type composed of the non-offset first flow path 17A, the first transition section 173 and the offset first flow path 17B.

Similarly, in the heat exchange core 1 according to another embodiment, the second flow path 27 includes two types of flow paths: one type composed of the non-offset second flow path 27A only; and the other type composed of the non-offset second flow path 27A, the second transition section 273 and the offset second flow path 27B.

As illustrated in FIGS. 7 and 8, in the heat exchange core 1 according to another embodiment, each of the first transition sections 173 is configured to be shifted toward one side along the first direction Dr1 (the upper side of FIGS. 7 and 8) from the end portion 18 toward the inside of the first flow path 17 along the second direction Dr2, that is, from the non-offset first flow path 17A toward the offset first flow path 17B.

Similarly, as illustrated in FIGS. 7 and 8, in the heat exchange core 1 according to another embodiment, each of the second transition sections 273 is configured to be shifted toward the above-mentioned one side along the first direction Dr1 (the upper side of FIGS. 7 and 8) from the end portion 28 toward the inside of the second flow path 27 along the second direction Dr2, that is, from the non-offset second flow path 27A toward the offset second flow path 27B.

In the heat exchange core 1 according to another embodiment illustrated in FIG. 6, the shift amount (offset amount ΔL) by which the offset flow paths 17B, 27B are shifted by the transition sections 173, 273 along the first direction Dr1 with respect to the non-offset flow paths 17A, 27A is equal to a separation pitch L1 between the first flow path 17 and the second flow path 27 adjacent to each other along the first direction Dr1.

Note that the offset amount ΔL may be smaller than the separation pitch L1 between the first flow path 17 and the second flow path 27.

The heat exchange core 1 according to some embodiments described above may be manufactured by layering of plates, casting or the like, but preferably by additive manufacturing with a metal powder as raw material.

In that case, the heat exchange core 1 is an additive manufactured body with a metal powder. Metal powders used in the additive manufacturing of the heat exchange core 1 are not particularly limited, but powders of stainless steel, titanium, and the like can be used.

The disclosure is not limited to the above-described embodiments, and includes embodiments obtained by modifying the above-described embodiments and embodiments obtained by appropriately combining these embodiments.

The contents described in each of the above embodiments are understood as follows, for example.

(1) A heat exchange core 1 according to at least one embodiment of the present disclosure includes a plurality of first layers 10 including a plurality of first flow paths 17, a first header 11 connected to the plurality of first flow paths 17, and a plurality of second layers 20 including a plurality of second flow paths 27 and disposed alternately with the first layers 10 in a layering direction (a first direction Dr1). The first header 11 includes a first main header 13 extending in the layering direction and a first sub header 15 provided on each of the plurality of first layers 10 and connected to the first main header 13. End portions 18 of some of the plurality of first flow paths 17 are connected to the first main header 13, and end portions 18 of the remainder of the plurality of first flow paths 17 are connected to the first sub header 15.

According to the above configuration (1), for example, the first flow paths 17 located relatively close to the first main header 13 are preferably connected to the first main header 13 so that a fluid directly flows into and out of the first main header 13. This makes it possible to relatively reduce the distance between the first main header 13 and the first flow paths 17, reduce pressure loss, and downsize the heat exchange core 1.

On the other hand, the first flow paths 17 located relatively far from the first main header 13 are preferably connected to the first sub header 15 so that a fluid flows into and out of the first main header 13 via the first sub header 15. This makes it possible to reduce pressure loss as compared with the case where the first flow paths 17 are extended to the first main header 13, and thus to reduce the difference in the flow rate of a fluid from the first flow paths 17 located relatively close to the first main header 13 and directly connected to the first main header 13. Consequently, variations in flow rate in the plurality of first flow paths 17 are suppressed, and thus the pressure loss can be reduced and the heat exchange efficiency can be improved in the heat exchange core 1.

Thus, according to the above configuration (1), the heat exchange core 1 having excellent heat exchange efficiency can be provided.

(2) In some embodiments, the above configuration (1) further includes a second header 21 connected to the plurality of second flow paths 27, the second header 21 not in communication with the first header 11. The second header 21 includes a second main header 23 extending in the layering direction (the first direction Dr1) and a second sub header 25 provided on each of the plurality of second layers 20 and connected to the second main header 23. End portions 28 of some of the plurality of second flow paths 27 are connected to the second main header 23, and end portions 28 of the remainder of the plurality of second flow paths 27 are connected to the second sub header 25.

According to the above configuration (2), for example, the second flow paths 27 located relatively close to the second main header 23 are preferably connected to the second main header 23 so that a fluid directly flows into and out of the second main header 23. This makes it possible to relatively reduce the distance between the second main header 23 and the second flow paths 27, reduce pressure loss, and downsize the heat exchange core 1.

On the other hand, the second flow paths 27 located relatively far from the second main header 23 are preferably connected to the second sub header 25 so that a fluid flows into and out of the second main header 23 via the second sub header 25. This makes it possible to reduce pressure loss as compared with the case where the second flow paths 27 are extended to the second main header 23, and thus to reduce the difference in the flow rate of a fluid from the second flow paths 27 located relatively close to the second main header 23 and directly connected to the second main header 23. Consequently, variations in flow rate in the plurality of second flow paths 27 are suppressed, and thus pressure loss can be reduced and heat exchange efficiency can be improved in the heat exchange core 1.

Thus, according to the above configuration (2), the heat exchange core 1 having excellent heat exchange efficiency can be provided.

(3) In some embodiments, in the above configuration (2), when viewed from the layering direction (the first direction Dr1), the first sub header 15 is preferably defined by the end portions 18 connected to the first sub header 15 and a roof wall portion 15W formed separated from the end portions 18 in an extending direction of the plurality of first flow paths 17 (a second direction Dr2). In at least a region of the first sub header 15 on a side of the first main header 13, a distance between the roof wall portion 15W and the end portions 18 connected to the first sub header 15 decreases further from the first main header 13.

When a fluid flows from the first sub header 15 to the first flow paths 17, the flow rate of the fluid flowing through the first sub header 15 decreases with an increasing distance from the first main header 13. On the other hand, when a fluid flows from the first flow paths 17 to the first sub header 15, the flow rate of the fluid flowing through the first sub header 15 increases with a decreasing distance to the first main header 13. According to the above configuration (3), the cross-sectional area of the flow path in the first sub header 15 decreases with an increasing distance from the first main header 13. This makes it possible to reduce differences in flow velocity of a fluid in the first sub header 15 due to differences in the distance from the first main header 13, and to suppress variations in flow rate between the first flow paths 17 connected to the first sub header 15.

(4) In some embodiments, in the above configuration (3), when viewed from the layering direction (the first direction Dr1), at least a part of the roof wall portion 15W is preferably positioned in a direction along which the part of the roof wall portion 15W becomes closer to the end portions 18 along the extending direction as distance between the part of the roof wall portion 15W and the first main header 13 increases along a direction (a third direction Dr3) orthogonal to an extending direction of the plurality of first flow paths 17 in an in-plane direction of the first layer.

According to the above configuration (4), at least a part of the roof wall portion 15W is inclined with respect to the extending direction of the plurality of first flow paths 17. For example, in the case where the heat exchange core 1 is formed by an additive manufacturing method and the extending direction of the first flow path 17 is defined as the layering direction in the additive manufacturing, the roof wall portion 15W as an overhang portion is inclined with respect to the layering direction in the additive manufacturing. Thus, according to the above configuration (4), the roof wall portion 15W can be formed without forming a support portion for the additive manufacturing.

(5) In some embodiments, in the above configuration (3) or (4), when viewed from the layering direction (the first direction Dr1), at least some of the end portions 18 connected to the first sub header 15 are preferably positioned in a direction along which the some of the end portions 18 become further away from the roof wall portion 15W along the extending direction as distance between the some of the end portions 18 and the first main header 13 increases along the direction (a third direction Dr3) orthogonal to the extending direction of the plurality of first flow paths 17 in an in-plane direction of the first layer.

According to the above configuration (5), by appropriately setting the distance between the end portions 18 and the roof wall portion 15W, the cross-sectional area of the flow path in the first sub header 15 can be appropriately set so as to suppress variations in flow rate between the first flow paths 17 connected to the first sub header 15.

(6) In some embodiments, in any one of the above configurations (3) to (5), the first sub header 15 is preferably adjacent to the second main header 23 with the roof wall portion 15W interposed between the first sub header 15 and the second main header 23.

According to the above configuration (6), the first sub header 15 and the second main header 23 come close to each other, and thus the heat exchange core 1 can be downsized.

(7) In some embodiments, in any one of the above configurations (1) to (6), the first header 11 preferably includes a one side first header 11X connected to the end portions 18 on one side of the plurality of first flow paths 17 and an other side first header 11Y connected to the end portions 18 on the other side of the plurality of first flow paths 17. The other side first header 11Y is preferably disposed on a side opposite to the one side first header 11X in the direction (the third direction Dr3) orthogonal to the extending direction of the plurality of first flow paths 17 in the in-plane direction of the first layer.

According to the above configuration (7), as compared with the case where the other side first header 11Y is disposed at substantially the same position as the one side first header 11X in the orthogonal direction described above, the difference in pressure loss between the plurality of first flow paths 17 can be reduced and thus the difference in flow rate between the plurality of first flow paths 17 can be reduced. This makes it possible to reduce the pressure loss and improve the heat exchange efficiency in the heat exchange core 1.

(8) In some embodiments, in the above configuration (7), of the plurality of first flow paths 17, one first flow path 17 that is connected to the first main header 13 at the one side first header 11X at the end portion 18 on one side is preferably connected to the first sub header 15 at the other side first header 11Y at the end portion 18 on the other side. Of the plurality of first flow paths 17, one first flow path 17 connected to the first main header 13 at the other side first header 11Y at the end portion 18 on the other side is preferably connected to the first sub header 15 at the one side first header 11X at the end portions 18 on the one side.

According to the above configuration (8), the difference in flow rate between the first flow path 17 connected to the first main header 13 in the one side first header 11X at its end portion 18 on one side and the first flow path 17 connected to the first main header 13 in the other side first header 11Y at its end portion 18 on the other side among the plurality of first flow paths 17 can be reduced.

(9) In some embodiments, in any one of the above configurations (1) to (8), when viewed from the layering direction (first direction Dr1), a wall portion 13W defining the first main header 13 preferably includes an inclined surface 13a inclined with respect to the extending direction of the plurality of first flow paths 17 (the second direction Dr2) and the direction (the third direction Dr3) orthogonal to the extending direction, in an in-plane direction of the first layer 10.

According to the above configuration (9), the wall portion 13W defining the first main header 13 is inclined with respect to the extending direction of the plurality of first flow paths 17. For example, in the case where the heat exchange core 1 is formed by an additive manufacturing method and the extending direction of the first flow path 17 is defined as the layering direction in the additive manufacturing, the wall portion 13W as an overhang portion is inclined with respect to the layering direction in the additive manufacturing. Thus, according to the above configuration (9), the wall portion 13W can be formed without forming a support portion for the additive manufacturing.

(10) In some embodiments, in any one of the above configurations (1) to (9), at least some of the wall portion 13W defining the first main header 13 preferably protrudes toward a side opposite to the plurality of first flow paths 17 along the extending direction of the plurality of first flow paths 17 (the second direction Dr2).

When the first main header 13 is disposed near the end portion of the heat exchange core 1 along the extending direction of the plurality of first flow paths 17 (the second direction Dr2), and when the heat exchange core 1 is designed so as not to unnecessarily increase the wall thickness of the wall portion 13W defining the first main header 13, at least some of the wall portion 13W defining the first main header 13 protrude toward the opposite side of the plurality of first flow paths 17 along the extending direction of the plurality of first flow paths 17. That is, according to the above configuration (10), the weight of the heat exchange core 1 can be reduced. Note that, in the case where the heat exchange core 1 is formed by an additive manufacturing method, the time required for material and manufacturing can be reduced by reducing the weight of the heat exchange core 1, allowing reduction of manufacturing cost.

(11) In some embodiments, in any one of the above configurations (1) to (10), at least some of the plurality of first flow paths 17 preferably overlap, along the layering direction, the plurality of second flow paths 27 disposed on one of one side or an other side along the direction (the third direction Dr3) orthogonal to the extending direction of the plurality of first flow paths 17 in the in-plane direction of the first layer 10.

According to the above configuration (11), heat is easily transferred between the first flow path 17 and the second flow path 27 and heat exchange between a fluid flowing through the first flow path 17 and a fluid flowing through the second flow path 27 is facilitated in a region where the first flow path 17 and the second flow path 27 overlap with each other along the layering direction (the first direction Dr1). Thus, heat exchange efficiency can be improved.

(12) In some embodiments, in any one of the above configurations (1) to (11), at least some of the plurality of first flow paths 17 may have a plurality of protruding portions 51 formed to protrude from wall surfaces (the wall surfaces of flow path partition walls 33 or interlayer partition walls 31) into the first flow paths 17, the wall surfaces defining the first flow paths 17.

According to the above configuration (12), the flow of a fluid is appropriately disturbed by the protruding portions 51 and thus the development of a boundary layer in the wall surfaces is suppressed. This increases heat transfer coefficient between the fluid and the wall portions defining the first flow paths 17 (the wall surfaces of the flow path partition walls 33 and the interlayer partition walls 31) and improves heat exchange efficiency.

(13) In some embodiments, in any one of the above configurations (1) to (12), at least some of the plurality of first flow paths 17 may include a plurality of communicating portions 61 formed in wall portions separating two of the first flow paths 17 adjacent to each other in the first layer 10 (the flow path partition wall 33) to enable the two of the first flow paths 17 to communicate with each other.

According to the above configuration (13), for example when a first flow path 17 gets clogged with a foreign matter, a fluid flowing from the upstream of a clogged portion may flow into another first flow path 17 via the communicating portion 61. Thus, the decrease in heat exchange efficiency due to the clogging of the first flow path 17 can be suppressed. Further, by providing a number of the communicating portions 61, the flow of a fluid is appropriately disturbed and thus the development of a boundary layer in wall surfaces (the wall surfaces of the flow path partition walls 33 and the interlayer partition walls 31) is suppressed. This increases heat transfer coefficient between the fluid and the wall portions defining the first flow paths 17 (the flow path partition walls 33 and the interlayer partition walls 31) and improves heat exchange efficiency.

(14) The heat exchanger 5 according to at least one embodiment of the present disclosure includes the heat exchange core 1 according to any one of the above configurations (1) to (13).

According to the above configuration (14), the heat exchanger 5 having excellent heat exchange efficiency can be provided.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A heat exchange core comprising:
a plurality of first layers comprising a plurality of first flow paths;
a first header connected to the plurality of first flow paths; and
a plurality of second layers comprising a plurality of second flow paths and disposed alternately with the plurality of first layers in a layering direction, wherein
the first header comprises
a first main header extending in the layering direction, and
a first sub header provided on each of the plurality of first layers and connected to the first main header,
end portions of some of the plurality of first flow paths are connected to the first main header, and
end portions of a remainder of the plurality of first flow paths are connected to the first sub header.

2. The heat exchange core according to claim 1, further comprising:
a second header connected to the plurality of second flow paths, the second header not in communication with the first header, wherein
the second header comprises
a second main header extending in the layering direction, and
a second sub header provided on each of the plurality of second layers and connected to the second main header,
end portions of some of the plurality of second flow paths are connected to the second main header, and
end portions of a remainder of the plurality of second flow paths are connected to the second sub header.

3. The heat exchange core according to claim 2, wherein
when viewed from the layering direction, the first sub header is defined by the end portions connected to the first sub header and a roof wall portion formed separated from the end portions in an extending direction of the plurality of first flow paths, and
in at least a region of the first sub header on a side of the first main header, a distance between the roof wall portion and the end portions connected to the first sub header decreases further from the first main header.

4. The heat exchange core according to claim 3, wherein
when viewed from the layering direction, at least a part of the roof wall portion is positioned in a direction along which the part of the roof wall portion becomes closer to the end portions along the extending direction as distance between the part of the roof wall portion and the first main header increases along a direction orthogonal to an extending direction of the plurality of first flow paths in an in-plane direction of the first layer.

5. The heat exchange core according to claim 3, wherein
when viewed from the layering direction, at least some of the end portions connected to the first sub header are positioned in a direction along which the some of the end portions become further away from the roof wall portion along the extending direction as distance between the some of the end portions and the first main header increases along the direction orthogonal to the extending direction of the plurality of first flow paths in an in-plane direction of the first layer.

6. The heat exchange core according to claim 3, wherein the first sub header is adjacent to the second main header with the roof wall portion interposed between the first sub header and the second main header.

7. The heat exchange core according to claim 1, wherein
the first header comprises:
a one side first header connected to the end portions on one side of the plurality of first flow paths, and
an other side first header connected to the end portions on an other side of the plurality of first flow paths,
the other side first header being disposed on a side opposite to the one side first header in the direction orthogonal to the extending direction of the plurality of first flow paths in an in-plane direction of the first layer.

8. The heat exchange core according to claim 7, wherein
of the plurality of first flow paths, one first flow path that is connected to the first main header at the one side first header at the end portion on the one side is connected to the first sub header at the other side first header at the end portion on the other side, and
of the plurality of first flow paths, one first flow path that is connected to the first main header at the other side first header at the end portion on the other side is connected to the first sub header at the one side first header at the end portion on the one side.

9. The heat exchange core according to claim 1, wherein, when viewed from the layering direction, a wall portion defining the first main header comprises an inclined surface inclined with respect to the extending direction of the plurality of first flow paths and the direction orthogonal to the extending direction, in an in-plane direction of the first layer.

10. The heat exchange core according to claim 1, wherein at least some of the wall portion defining the first main header protrudes toward a side opposite to the plurality of first flow paths along the extending direction of the plurality of first flow paths.

11. The heat exchange core according to claim 1, wherein at least some of the plurality of first flow paths at least partially overlap, along the layering direction, the plurality of second flow paths disposed on one of one side or an other side along the direction orthogonal to the extending direction of the plurality of first flow paths in an in-plane direction of the first layer.

12. The heat exchange core according to claim 1, wherein at least some of the plurality of first flow paths comprise a plurality of protruding portions formed to protrude from wall surfaces into the first flow paths, the wall surfaces defining the first flow paths.

13. The heat exchange core according to claim 1, wherein at least some of the plurality of first flow paths comprise a plurality of communicating portions formed in wall portions separating two of the first flow paths adjacent to each other in the first layer to enable the two of the first flow paths to communicate with each other.

14. A heat exchanger comprising the heat exchange core according to claim 1.
